(19) United States
(12) Patent Application Publication
(10) Pub. No.: US 2015/0134676 A1
(43) Pub. Date: May 14, 2015

(54) AMORPHOUS DATA QUERY FORMULATION

(71) Applicant: International Business Machines Corporation, Armonk, NY (US)

(72) Inventors: TAMER E. ABUELSAAD, Somers, NY (US); Gregory Jensen Boss, Saginaw, MI (US); Craig Matthew Trim, Sylmar, CA (US); Albert Tien-yuen Wong, Whittier, CA (US)

(73) Assignee: International Business Machines Corporation, Armonk, NY (US)

(21) Appl. No.: 14/076,752

(22) Filed: Nov. 11, 2013

(51) Int. Cl. G06F 17/30

(52) U.S. Cl. CPC G06F 17/30401
USPC 707/756

(57) ABSTRACT

A view of a data cube is produced, including a set of data entities available from the data cube. Information is presented, as metadata associated with the data cube, to guide a selection of a subset of data entities. A selection of a subset is received. A sub-query is constructed, configured according to a configuration standard adopted in the data cube, and to extract a set of records containing the selected subset of data entities. Using the sub-query on the data cube, the set of records is extracted as an intermediate set that conforms to the configuration standard. The intermediate set is normalized with a second intermediate set extracted from a second data cube using a second sub-query and conforming to a second configuration standard. The normalizing results in a normalized result set. The query is executed on the normalized result set to produce an answer to the query.

### TECHNICAL FIELD

The present invention relates generally to a method, system, and computer program product for querying data. More particularly, the present invention relates to a method, system, and computer program product for amorphous data query formulation.

### BACKGROUND

A data store is a repository of amorphous data. Generally, amorphous data is data that does not conform to any particular form or structure. Typically, data sourced from several different sources of different types is amorphous because the sources provide the data in varying formats, organized in different ways, and often in unstructured form.

A data cube is a quantum of data that can be sold, purchased, borrowed, installed, loaded, or otherwise used in a computation. Several methods for querying amorphous data from one or more data stores are presently in use. Presently, the amorphous data that is to be queried is first organized in a data structure with a suitable number of columns to represent all of the amorphous data, e.g., as a multi-dimensional data cube, using any known technique for constructing such data structures. A query is then constructed corresponding to the dimensions represented in the data structure.

Querying amorphous data produces a result set that is also amorphous. A result set is data resulting from executing a query. Executing a portion of a query, or a sub-query, also results in a result set.

Normalization of data is a process of organizing the data. Structuring unstructured data, for example, casting or transforming amorphous data into some structured form, is an example of normalizing amorphous data.

### SUMMARY

The illustrative embodiments provide a method, system, and computer program product for amorphous data query formulation. An embodiment includes a method for amorphous data query formulation. The embodiment produces, using a processor and a memory, a view of a data cube, wherein the data cube is a member of a set of data cubes selected to answer a query, and wherein the view comprises a set of data entities available from the data cube. The embodiment presents, as metadata associated with the data cube, information to guide a selection of a subset of data entities from the set of data entities. The embodiment receives a selection of a subset of the set of data entities. The embodiment constructs a sub-query, the sub-query configured according to a configuration standard adopted in the data cube, the sub-query configured to extract a set of records containing the selected subset of data entities. The embodiment extracts, using the sub-query on the data cube, the set of records, the set of records forming an intermediate result set, wherein the intermediate result set conforms to the configuration standard of the data cube. The embodiment normalizes the intermediate result set with a second intermediate result set extracted from a second data cube using a second sub-query, wherein the second intermediate result set conforms to a second configuration standard, the normalizing resulting in a normalized result set. The embodiment executes the query on the normalized result set to produce an answer to the query.

Another embodiment includes a computer program product for amorphous data query formulation. The embodiment further includes one or more computer-readable tangible storage devices. The embodiment further includes program instructions, stored on at least one of the one or more storage devices, to produce, using a processor and a memory, a view of a data cube, wherein the data cube is a member of a set of data cubes selected to answer a query, and wherein the view comprises a set of data entities available from the data cube. The embodiment further includes program instructions, stored on at least one of the one or more storage devices, to present, as metadata associated with the data cube, information to guide a selection of a subset of data entities from the set of data entities. The embodiment further includes program instructions, stored on at least one of the one or more storage devices, to receive a selection of a subset of the set of data entities. The embodiment further includes program instructions, stored on at least one of the one or more storage devices, to construct a sub-query, the sub-query configured according to a configuration standard adopted in the data cube, the sub-query configured to extract a set of records containing the selected subset of data entities. The embodiment further includes program instructions, stored on at least one of the one or more storage devices, to extract, using the sub-query on the data cube, the set of records, the set of records forming an intermediate result set, wherein the intermediate result set conforms to the configuration standard of the data cube. The embodiment further includes program instructions, stored on at least one of the one or more storage devices, to normalize the intermediate result set with a second intermediate result set extracted from a second data cube using a second sub-query, wherein the second intermediate result set conforms to a second configuration standard, the normalizing resulting in a normalized result set. The embodiment further includes program instructions, stored on at least one of the one or more storage devices, to execute the query on the normalized result set to produce an answer to the query.

Another embedment includes a computer system for amorphous data query formulation. The embodiment further includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to produce, using a processor and a memory, a view of a data cube, wherein the data cube is a member of a set of data cubes selected to answer a query, and wherein the view comprises a set of data entities available from the data cube. The embodiment further includes program instructions, stored on at least one of the one or more storage devices for execution by at least one of the one or more processors via at least one of the one or more memories, to present, as metadata associated with the data cube, information to guide a selection of a subset of data entities from the set of data entities. The embodiment further includes program instructions, stored on at least one of the one or more storage devices for execution by at least one of the one or more processors via at least one of the one or more memories, to receive a selection of a subset of the set of data entities. The embodiment further includes program instructions, stored on at least one of the one or more storage devices for execution by at least one of the one or more processors via at least one of the one or more memories, to construct a sub-query, the sub-query configured according to a configuration standard adopted in the data cube, the sub-query configured to extract a set of records containing the selected subset of data entities. The embodiment further includes program instructions, stored on at least one of the one or more storage devices for execution by at least one of the one or more processors via at least one of the one or more memories, to extract, using the sub-query on the data cube, the set of records, the set of records forming an intermediate result set, wherein the intermediate result set conforms to the configuration standard of the data cube. The embodiment further includes program instructions, stored on at least one of the one or more storage devices for execution by at least one of the one or more processors via at least one of the one or more memories, to normalize the intermediate result set with a second intermediate result set extracted from a second data cube using a second sub-query, wherein the second intermediate result set conforms to a second configuration standard, the normalizing resulting in a normalized result set. The embodiment further includes program instructions, stored on at least one of the one or more storage devices for execution by at least one of the one or more processors via at least one of the one or more memories, to execute the query on the normalized result set to produce an answer to the query.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a process for amorphous data query formulation in accordance with an illustrative embodiment;

FIG. 4 depicts a block diagram of a configuration for amorphous data query formulation in accordance with an illustrative embodiment; and

FIG. 5 depicts a flowchart of an example process for amorphous data query formulation in accordance with an illustrative embodiment.

### DETAILED DESCRIPTION

Much like an application store contains applications, a data store according to the illustrative embodiments contains numerous data cubes. In a manner similar to obtaining an application from an application store for use on a device, a user can obtain one or more data cubes to use in the user's query. For example, a user can use a shopping cart application to select data cubes from a data store. The user can then buy, borrow, download, install, or otherwise use the selected data cubes in the user's query in the manner of an embodiment.

The illustrative embodiments recognize that when a query is directed to a data store, typically several data cubes have to participate in answering the query. For example, some but not all elements of the query may be available in one data cube, and one or more other data cubes may provide the remaining elements to completely answer the query.

Presently, when multiple data cubes participate in answering a query, the inconsistent structures adopted in different data cubes—the amorphous nature of the data cubes—poses a computational problem. For example, some cubes may be organized in a relational organization conducive to accepting and answering queries in Structured Query Language (SQL) whereas some other data cubes may be organized in a non-relational structure that may not accept SQL queries.

Having to use amorphous combination of data cubes to answer a query is a common problem in querying data stores. Furthermore, often, the application or user who submits the query is in control of determining the data elements required to answer the query, and the language in which the query is presented. Presently, before a query can be executed against a set of more than one data cubes, the participant data cubes have to be normalized to a common structure so that the resulting normalized data cubes can accept the query in the language in which the query is specified.

The illustrative embodiments recognize that normalizing the data cubes before the query can be targeted to the data cubes is inefficient and computationally expensive. Therefore, the illustrative embodiments recognize that the presently available solutions for querying amorphous data have to be improved.

The illustrative embodiments used to describe the invention generally address and solve the above-described problems and other problems related to querying amorphous data. The illustrative embodiments provide a method, system, and computer program product for amorphous data query formulation.

An embodiment allows a user or application (collectively, “user”) to select the data cubes that should participate in answering a query. The embodiment presents the data organization of the data cubes, such as columns or dimensions of the cube (entities), to the user. In one embodiment, not only the actual entities configured in the data cubes, but also the derivative entities computed or computable from the actual entities are presented.

The use or the application selects the entities, whether actual or derived, from an embodiment's presentation of the data cubes. An embodiment extracts the selected entities from their respective data cubes. In one embodiment, an entity in one cube is extracted by relating the entity to one or more entities in another cube. As an example, without implying a limitation thereto, one manner of relating entities in different relational data cubes is by performing a join operation on the cubes using the entities. Differently structured cubes can be related to one another in many different ways and the same are contemplated within the scope of the illustrative embodiments.

Each set of extracted entities from each participant data cube forms an intermediate result set. The intermediate result set (result set) is amorphous owing to the amorphous nature of the participant data cubes. An embodiment normalizes the extracted entities into a normalized result set. The embodiment executes the query against the normalized result set. One embodiment stores the normalized result set as a data cube.

An embodiment optimizes the result set normalization process. For example, the embodiment determines the costs of different normalization options and selects the least cost option to normalize the result set.

An embodiment assists the user in selecting the entities from the data cubes by providing metadata of the participant data cubes. In one embodiment, the metadata informs the user about the authorization needed, restrictions applicable, conditions applicable, and other access controls to use a particular data cube or a part thereof. In another embodiment, the metadata informs the user about a cost, factors affecting a cost or extracting the selected entities from a data cube.

The illustrative embodiments are described with respect to, certain data formats, structures, entities, relationships, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

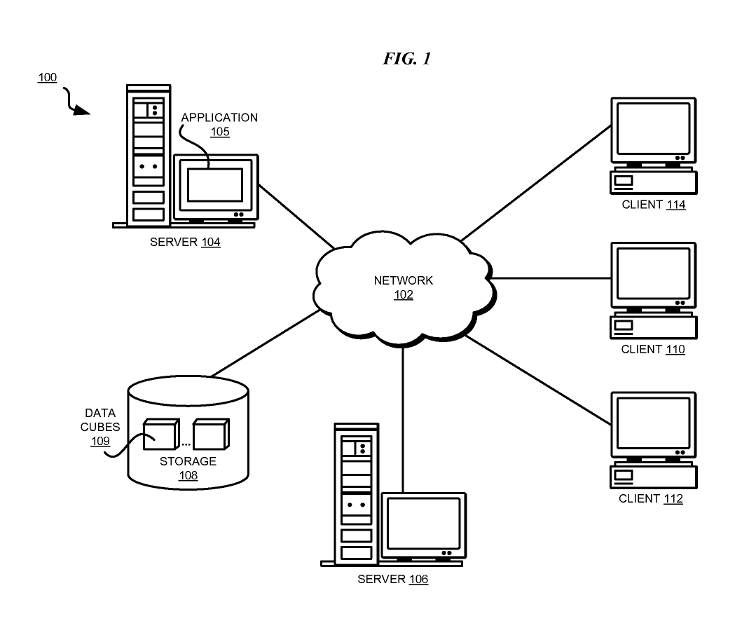

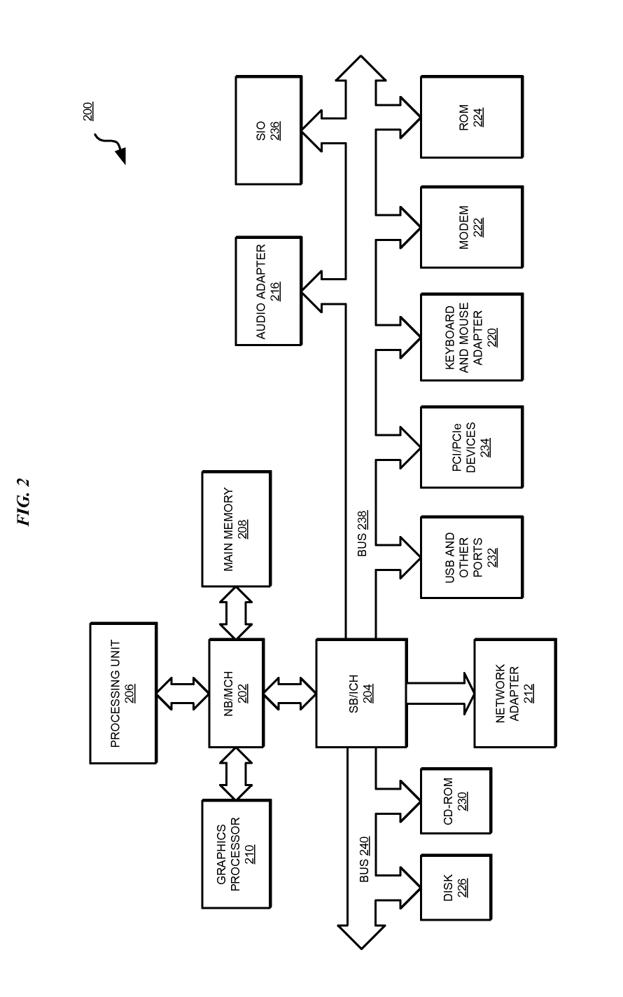

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an embodiment. Application 105 in server 104 implements an embodiment described herein. Data cubes 109 are cubes located in a data store, such as a data store using storage 108. Data cubes 109 are amorphous in that one data cube in data cubes 109 is organized differently and according to a different standard or specification than another data cube in data cubes 109. Some or all of data cubes 109 can participate in a query.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

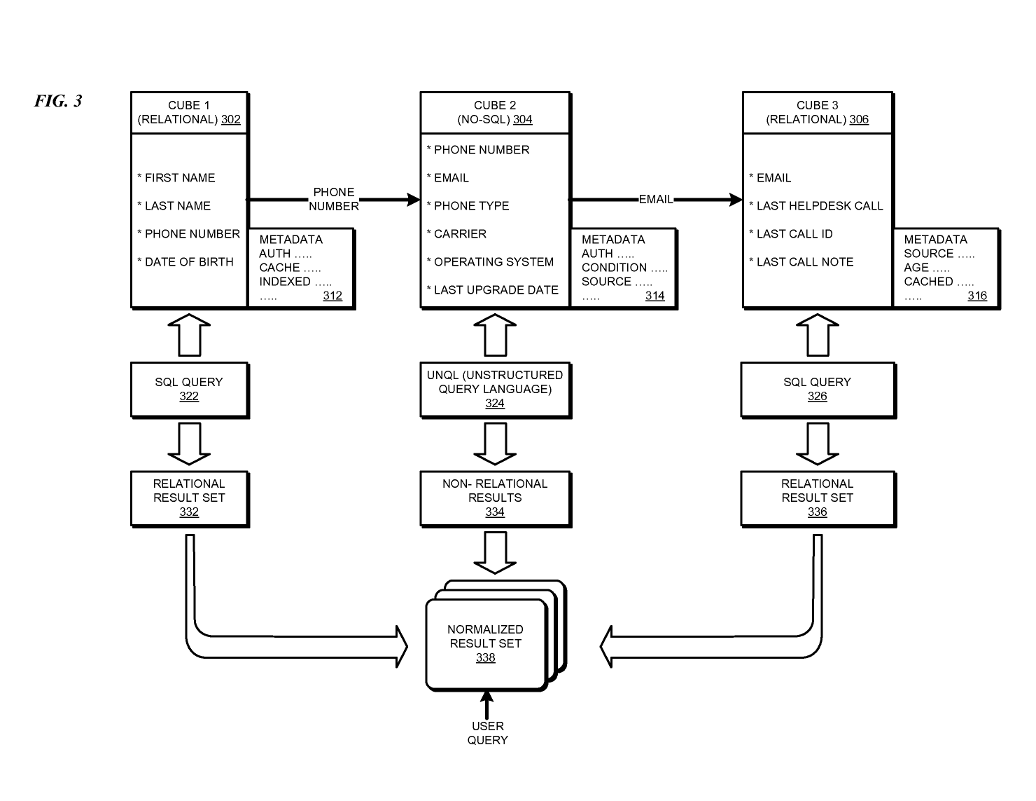

With reference to FIG. 3, this figure depicts a block diagram of a process for amorphous data query formulation in accordance with an illustrative embodiment. Cubes 302, 304, and 306 are amorphous cubes from cubes 109 in FIG. 1.

Suppose a user wishes to execute query 340 on a data store to find a list email addresses of individuals whose last names begin with the letter “A” and who made helpdesk calls. The user selects a set of data cubes that can satisfy this query. As an example to illustrate the operation of an embodiment, assume that the selected set of data cubes includes cubes 302, 304, and 306.

Only as an illustrative example, and without implying any limitation thereto on an embodiment, assume that cube 302, labeled “cube 1” is an SQL addressable relational cube having the entities “first name”, “last name”, and “phone number” represented therein. Similarly, as an example, assume that cube 304, labeled “cube 2” is a Non SQL addressable cube having the entities “phone number”, “email”, “phone type”, “carrier”, “operating system”, and “last upgrade date” represented therein. Similarly, as an example, assume that cube 306, labeled “cube 3” is another SQL addressable relational cube having the entities “email”, “last helpdesk call”, “last call id”, and “last call note” represented therein.

An embodiment, when implemented in application 105 in FIG. 1, presents a view similar to the contents of cubes 302, 304, and 306 to the user. The embodiment shows the user that cube 302 and cube 304 are related by the phone number entities present in each of those cubes, and cube 304 and cube 306 are related by the email entities present in both cubes 304 and 306.

One embodiment further presents metadata 312, 314, and 316 to the user to facilitate the user's entity selection decision process. Generally, the elements presented in metadata 312, 314, or 316 are selected and provided so that the user can be informed about technical and authorization limitations or restrictions associated with using a corresponding data cube.

For example, an authorization element, as in metadata 312, may convey to the user the authorization level required to use data cube 302, e.g., as a view-only data cube, or that cube 302 can or cannot participate in a relationship with other data cubes for a certain purpose, or whether another access control, for example the user's authorization level, applies to cube 302. Such information via metadata 312 is useful to the user in determining whether to select cube 302 for participation in the query, how to use cube 302 in answering a query, and whether to use cube 302 or an entity therein in a certain way.

As another example, the cost of extracting an entity from a cube is dependent upon whether all or part of the cube is cached or has to be brought into memory for participation in a query. Cached or partially cached cubes can have better query performance than non-cached cubes. Similar considerations apply when a cube or a portion thereof is indexed or not indexed. As an example, metadata 312 and 316 present the caching status, indexing status, and other performance considerations related to the corresponding data cubes 302 and 306, respectively. For example, when the user has access to two cubes that can provide the last names entity, but one of the cubes is cached and another is not, the user's decision to select the more efficient cached cube may be guided by an embodiment presenting these or other similarly purposed performance information in the metadata of the cubes in question.

As another example, the provenance of a source that provided the data in a data cube may be a factor in the user's cube selection decision. A cube whose metadata indicates a source of higher provenance may be preferable to another cube, which either does not have the source information or has a source of lower provenance. Similar considerations apply with the age of the data available in a cube. As an example, metadata 314 and 316 present the source or provenance information, age of data, and other reliability considerations related to the corresponding data cubes 304 and 306, respectively. For example, when the user has access to two cubes that can provide the last names entity, but one of the cubes is newer or from a source of higher than threshold provenance that the other, the user's decision to select the more reliable or newer data cube may be guided by an embodiment presenting these or other similarly purposed reliability information in the metadata of the cubes in question.

The depicted metadata elements pertaining to authorization, performance, and reliability are not intended to be limiting on the illustrative embodiments. Generally within the scope of the illustrative embodiments, metadata 312, 314, and 316 can include these, additional, or different but similarly purposed metadata elements and the same are contemplated within the scope of the illustrative embodiments. For example, a total size information in the metadata of competing data cubes may guide the user to select the smallest of the competing data cubes for faster query execution.

Upon considering metadata 312, 314, and 316, the user selects the phone number entity to extract from cube 302, the phone number and email entities to extract from cube 304, and the email entity to extract from cube 306. The embodiment constructs sub-queries 312, 314, and 316 to extract the entities selected for extraction from cubes 302, 304, and 306, respectively.

Particularly, the embodiment uses the information that cube 302 is a SQL capable relational cube and selects SQL as the language of choice to construct sub-query 322. Similarly, the embodiment uses the information that cube 304 is a non SQL capable cube and selects UnSQL to construct sub-query 324. UnSQL is a query language suitable for addressing NoSQL data structures. Similarly, the embodiment uses the information that cube 306 is a SQL capable relational cube and selects SQL as the language of choice to construct sub-query 326.

Intermediate result sets 332, 334, and 336 result from an embodiment executing sub-query 322 on cube 302, sub-query 324 on cube 304, and sub-query 326 on cube 306, respectively. Intermediate result sets 332, 334, and 336 together form an amorphous intermediate result set. For example, sub-query 322 extracts entities from relational cube 302, and results in relational intermediate result set 332; sub-query 324 extracts entities from non relational cube 304, and results in non relational intermediate result set 334; and sub-query 326 extracts entities from relational cube 306, and results in relational intermediate result set 336.

An embodiment normalizes intermediate result sets 332, 334, and 336 into normalized result set 338. The embodiment executes user query 340 on normalized result set 338. In one embodiment, normalized result set 338 is expressed as a data cube, which can be stored in the data store for future queries.

One embodiment further optimizes the normalization of intermediate result sets 332, 334, and 336 in to normalized result set 338. For example, suppose that only one hundred records appear in result set 332 corresponding to individuals whose last names begin with the letter “A”. Further suppose that cube 306 only includes one thousand records but cube 304 includes one million records. Suppose that an embodiment cannot reduce the number of records extracted from cube 304 into result set 334, and all one million records have to be extracted into result set 334. Further suppose that all one thousand records have to be extracted into result set 336 as well.

An embodiment determines that one normalization option is to convert result set 334 into a relational form so that all result sets are in relational form and can be normalized from their relational forms. The embodiment determines that another normalization option is to convert result sets 332 and 336 into the non-relational form used by result set 334, so that all result sets are in a common non-relational form and can be normalized there from.

By comparing the costs of conversion in both options the embodiment determines that the second option is computationally less expensive than the first option because of the number of records to be converted. The cost of the first option may be used as a threshold, or another threshold cost may be used, to identify the second option as the option of choice in the above example. Accordingly, the embodiment selects the second option as the optimum option for normalizing intermediate result sets 332, 334, and 336. Any threshold can similarly be used to determine which normalization option to select in a given implementation.

Note that the example options and the example manner of selecting an optimum option for normalization described above are not intended to be limiting on the illustrative embodiments. Those of ordinary skill in the art will be able to conceive many other normalization situations warranting many other normalization options and many other ways of deciding which of those options are optimal under the given set of circumstances, and the same are contemplated within the scope of the illustrative embodiments.

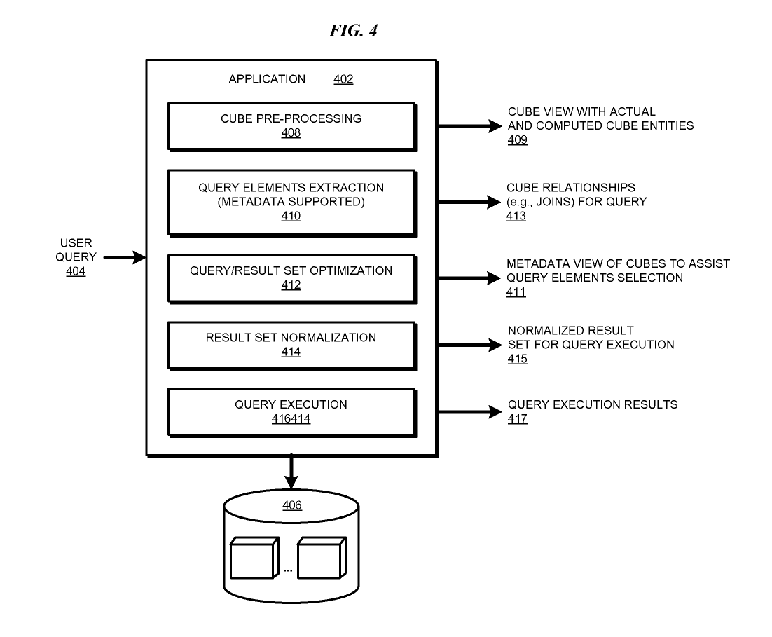

With reference to FIG. 4, this figure depicts a block diagram of a configuration for amorphous data query formulation in accordance with an illustrative embodiment. Application 402 is an example of application 105 in FIG. 1, and can be used to execute the process described in FIG. 3. User query 404 is an example of user query 340 in FIG. 3, which has to be executed using some data cubes from repository 406.

Application 402 includes component 408, which performs cube pre-processing. For example, component produces cube view 409 of the data cubes selected by the user from repository 406 for answering query 404. Cue view 409 presents a user with the ability to inspect and select the actual or computed entities available from a selected cube. The presentation of cubes 302, 304, and 306 in FIG. 3, or variations thereof is an example of cube view 409 produced by component 408.

Component 408, in the course of pre-processing the selected data cubes also collects, computes, or determines metadata 411 associated with each selected cube. The presentation of metadata 312, 314, and 316 in FIG. 3, or variations thereof, is an example of metadata provided in cube view 409 by component 408. Component 408 also presents cube relationships 413 suitable for answering query 404. Component 408 computes cube relationships 413 subject to any restrictions, conditions, or limitations in metadata 411.

Component 410 performs the query elements extraction from the various cubes presented in cube view 409. For example, component 410 executes queries 322, 324, and 326 on cubes 302, 304, and 306, respectively, to generate intermediate result sets 332, 334, and 336, respectively, in FIG. 3.

Component 412 constructs the sub-queries for extracting the user-selected entities, which form the elements for answering query 404. For example, component 412 constructs, and optimizes, sub-queries 322, 324, and 326 in FIG. 3. Component 412 also performs any optimization, post-processing, or both, on intermediate result sets resulting from executing the sub-queries.

Component 414 normalizes the intermediate result sets obtained from sub-query execution by component 410. Component 414 produces normalized intermediate result set 15, which can then be used for executing query 404 in the manner described with respect to FIG. 3. Normalized result set 415 is an example of normalized result set 338 in FIG. 3. Query execution component 416 executes query 404 on normalized result set 415, and produces query execution results 417.

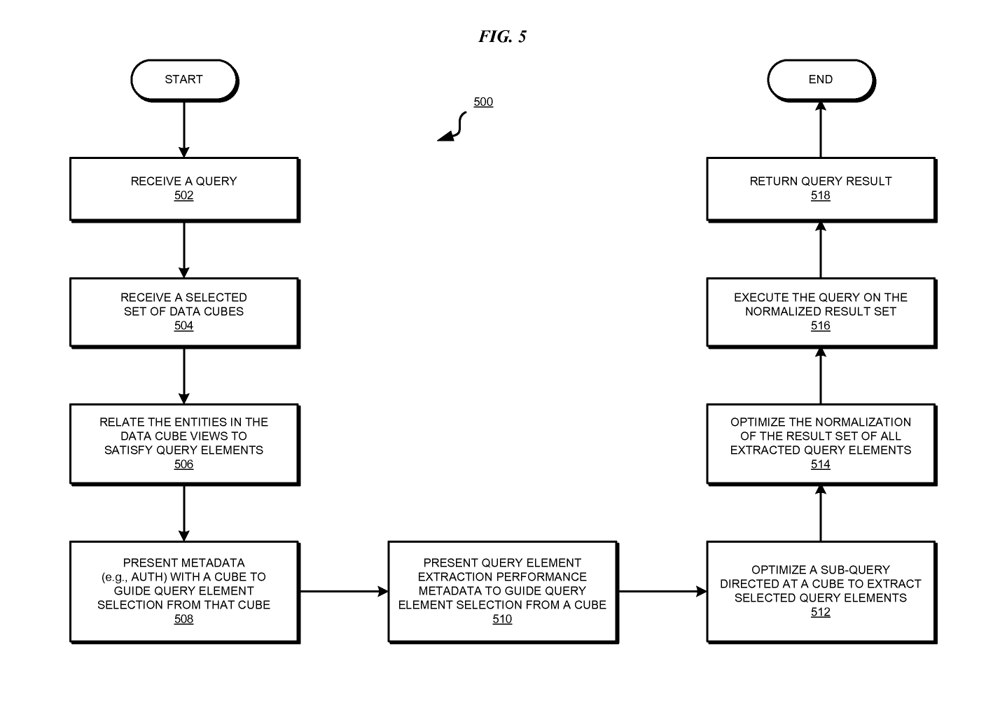

With reference to FIG. 5, this figure depicts a flowchart of an example process for amorphous data query formulation in accordance with an illustrative embodiment. Process 500 can be implemented in application 402 in FIG. 4.

The application receives a query (block 502). The application receives a selected set of data cubes (block 504).

The application relates the entities in the data cube views such that the cubes can satisfy the call of the query (block 506). The application presents metadata, including but not limited to authorization, caching or indexing states, or reliability metadata, with a cube view to guide query element selection from that cube (block 508). The application further presents with a cube view, performance metadata indicative of a cost of extracting the selected entities or query elements from the cube (block 510).

The application optimizes a sub-query directed at a cube to extract the query elements selected from that cube (block 512). The application optimizes the normalization of the result sets of all extracted query elements (block 514). The application executes the query on the normalized result set (block 516). The application returns the query results (block 518). The application ends process 500 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for amorphous data query formulation.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for amorphous data query formulation, the method comprising:
producing, using a processor and a memory, a view of a data cube, wherein the data cube is a member of a set of data cubes selected to answer a query, and wherein the view comprises a set of data entities available from the data cube;
presenting, as metadata associated with the data cube, information to guide a selection of a subset of data entities from the set of data entities;
receiving a selection of a subset of the set of data entities;
constructing a sub-query, the sub-query configured according to a configuration standard adopted in the data cube, the sub-query configured to extract a set of records containing the selected subset of data entities;
extracting, using the sub-query on the data cube, the set of records, the set of records forming an intermediate result set, wherein the intermediate result set conforms to the configuration standard of the data cube;
normalizing the intermediate result set with a second intermediate result set extracted from a second data cube using a second sub-query, wherein the second intermediate result set conforms to a second configuration standard, the normalizing resulting in a normalized result set; and
executing the query on the normalized result set to produce an answer to the query.

2. The method of claim 1, wherein the normalizing avoids normalizing the data cube and the second data cube, further comprising:
selecting one of the configuration standard and the second configuration standard, forming a selected configuration standard to use in the normalizing, such that the selected configuration standard causes the normalizing to occur at a lower than a threshold computational cost.

3. The method of claim 1, further comprising:
constructing a second sub-query, the second sub-query configured according to the second configuration standard adopted in the second data cube, the second sub-query configured to extract a second set of records containing a selected subset of data entities from the second set of data entities.

4. The method of claim 1, wherein the information comprises information corresponding to a reliability of data entities in the data cube.

5. The method of claim 4, wherein the reliability of the data entities is indicated by one of (i) an age of the data cube, and (ii) a provenance of a source that supplied the data entities in the data cube.

6. The method of claim 1, wherein the information comprises information corresponding to a combinability of a data entity from the set of data entities with a second data cube.

7. The method of claim 1, wherein the information comprises information corresponding to state of storage of the data cube.

8. The method of claim 1, further comprising:
receiving the query from a user; and
receiving an input to select a set of data cubes from a data store, the set of data cubes including the data cube and a second data cube.

9. The method of claim 1, further comprising:
relating the view of the data cube to a second view of a second data cube, the second data cube comprising a second set of data entities, wherein the relating associates a data entity in the set of data entities to an entity in the second set of data entities.

10. The method of claim 1, wherein the data cube is a multi-dimensional data structure containing a second set of data entities, wherein the set of data entities includes the second set of data entities and another set of data entities computable from the second set of data entities using a data entity in a second data cube.

11. The method of claim 1, further comprising:
storing the normalized result set in a data store as a third data cube.

12. A computer program product comprising one or more computer-readable tangible storage devices and computer-readable program instructions which are stored on the one or more storage devices and when executed by one or more processors, perform the method of claim 1.

13. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

14. A computer program product for amorphous data query formulation, the computer program product comprising:
one or more computer-readable tangible storage devices;
program instructions, stored on at least one of the one or more storage devices, to produce, using a processor and a memory, a view of a data cube, wherein the data cube is a member of a set of data cubes selected to answer a query, and wherein the view comprises a set of data entities available from the data cube;
program instructions, stored on at least one of the one or more storage devices, to present, as metadata associated with the data cube, information to guide a selection of a subset of data entities from the set of data entities;
program instructions, stored on at least one of the one or more storage devices, to receive a selection of a subset of the set of data entities;
program instructions, stored on at least one of the one or more storage devices, to construct a sub-query, the sub-query configured according to a configuration standard adopted in the data cube, the sub-query configured to extract a set of records containing the selected subset of data entities;
program instructions, stored on at least one of the one or more storage devices, to extract, using the sub-query on the data cube, the set of records, the set of records forming an intermediate result set, wherein the intermediate result set conforms to the configuration standard of the data cube;
program instructions, stored on at least one of the one or more storage devices, to normalize the intermediate result set with a second intermediate result set extracted from a second data cube using a second sub-query, wherein the second intermediate result set conforms to a second configuration standard, the normalizing resulting in a normalized result set; and
program instructions, stored on at least one of the one or more storage devices, to execute the query on the normalized result set to produce an answer to the query.

15. The computer program product of claim 14, wherein the program instructions to normalize avoid normalizing the data cube and the second data cube, further comprising:
program instructions, stored on at least one of the one or more storage devices, to select one of the configuration standard and the second configuration standard, forming a selected configuration standard to use in the normalizing, such that the selected configuration standard causes the normalizing to occur at a lower than a threshold computational cost.

16. The computer program product of claim 14, further comprising:
program instructions, stored on at least one of the one or more storage devices, to construct a second sub-query, the second sub-query configured according to the second configuration standard adopted in the second data cube, the second sub-query configured to extract a second set of records containing a selected subset of data entities from the second set of data entities.

17. The computer program product of claim 14, wherein the information comprises information corresponding to a reliability of data entities in the data cube.

18. The computer program product of claim 17, wherein the reliability of the data entities is indicated by one of (i) an age of the data cube, and (ii) a provenance of a source that supplied the data entities in the data cube.

19. The computer program product of claim 14, wherein the information comprises information corresponding to a combinability of a data entity from the set of data entities with a second data cube.

20. A computer system for amorphous data query formulation, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to produce, using a processor and a memory, a view of a data cube, wherein the data cube is a member of a set of data cubes selected to answer a query, and wherein the view comprises a set of data entities available from the data cube;
program instructions, stored on at least one of the one or more storage devices for execution by at least one of the one or more processors via at least one of the one or more memories, to present, as metadata associated with the data cube, information to guide a selection of a subset of data entities from the set of data entities;
program instructions, stored on at least one of the one or more storage devices for execution by at least one of the one or more processors via at least one of the one or more memories, to receive a selection of a subset of the set of data entities;
program instructions, stored on at least one of the one or more storage devices for execution by at least one of the one or more processors via at least one of the one or more memories, to construct a sub-query, the sub-query configured according to a configuration standard adopted in the data cube, the sub-query configured to extract a set of records containing the selected subset of data entities;
program instructions, stored on at least one of the one or more storage devices for execution by at least one of the one or more processors via at least one of the one or more memories, to extract, using the sub-query on the data cube, the set of records, the set of records forming an intermediate result set, wherein the intermediate result set conforms to the configuration standard of the data cube;
program instructions, stored on at least one of the one or more storage devices for execution by at least one of the one or more processors via at least one of the one or more memories, to normalize the intermediate result set with a second intermediate result set extracted from a second data cube using a second sub-query, wherein the second intermediate result set conforms to a second configuration standard, the normalizing resulting in a normalized result set; and
program instructions, stored on at least one of the one or more storage devices for execution by at least one of the one or more processors via at least one of the one or more memories, to execute the query on the normalized result set to produce an answer to the query.
